(19) United States
(12) Patent Application Publication
(10) Pub. No.: US 2022/0130407 A1
(43) Pub. Date: Apr. 28, 2022

(54) METHOD FOR ISOLATING SOUND, ELECTRONIC EQUIPMENT, AND STORAGE MEDIUM

(71) Applicant: BEIJING SENSETIME TECHNOLOGY DEVELOPMENT CO., LTD., Beijing (CN)

(72) Inventors: Xudong XU, Beijing (CN); Bo DAI, Beijing (CN); Dahua LIN, Beijing (CN)

(21) Appl. No.: 17/569,700

(22) Filed: Jan. 6, 2022

Related U.S. Application Data
(63) Continuation of application No. PCT/CN2019/120586, filed on Nov. 25, 2019.

(30) Foreign Application Priority Data
Aug. 23, 2019 (CN) 201910782828.X

(51) Int. Cl. G10L 21/0308; G10L 25/18; G10L 25/57; G06K 9/62

(52) U.S. Cl. CPC G10L 21/0308; G06K 9/6232; G10L 25/57; G10L 25/18

(57) ABSTRACT

Input sound spectra are acquired. The input sound spectra include sound spectra corresponding to multiple sound sources. Predicted sound spectra are isolated from the input sound spectra by performing spectrum isolation processing on the input sound spectra. Updated input sound spectra are acquired by removing the predicted sound spectra from the input sound spectra. Next isolated predicted sound spectra continue to be acquired through the updated input sound spectra, until the updated input sound spectra include no sound spectrum.

### CROSS-REFERENCE TO RELATED APPLICATIONS

This application is a continuation of International Application No. PCT/CN2019/120586 filed on Nov. 25, 2019, which per se claims benefit of priority to Chinese Application No. 201910782828.X titled METHOD AND DEVICE FOR ISOLATING SOUND, AND ELECTRONIC EQUIPMENT, filed on Aug. 23, 2019, the contents of which are incorporated herein by reference in their entirety.

### BACKGROUND

A main task in sound isolation is to isolate mixed sounds including sounds from multiple sound sources using a model. In related art, mixed sounds may be isolated using a neural network model. In general, isolation may be performed once. That is, sounds from all sound sources in mixed sounds may be isolated via one processing.

### SUMMARY

The subject disclosure relates to the field of machine learning, and more particularly, to a method for isolating a sound, electronic equipment, and a storage medium.

In view of this, embodiments herein provide a method for isolating a sound, electronic equipment, and a storage medium, capable of improving generalizability of a model as well as improving an effect of sound isolation.

According to a first aspect herein, a method for isolating a sound includes:

acquiring input sound spectra, the input sound spectra including sound spectra corresponding to multiple sound sources;

isolating predicted sound spectra from the input sound spectra by performing spectrum isolation processing on the input sound spectra;

acquiring updated input sound spectra by removing the predicted sound spectra from the input sound spectra; and

continuing to acquire next isolated predicted sound spectra through the updated input sound spectra, until the updated input sound spectra include no sound spectrum.

According to a second aspect herein, a device for isolating a sound includes an input acquiring module, a spectrum isolating module, and a spectrum updating module.

The input acquiring module is configured to acquire input sound spectra. The input sound spectra include sound spectra corresponding to multiple sound sources.

The spectrum isolating module is configured to isolate predicted sound spectra from the input sound spectra by performing spectrum isolation processing on the input sound spectra; and continue to acquire next isolated predicted sound spectra through updated input sound spectra, until the updated input sound spectra include no sound spectrum.

The spectrum updating module is configured to acquire the updated input sound spectra by removing the predicted sound spectra from the input sound spectra.

According to a third aspect herein, electronic equipment includes memory and a processor. The memory is configured to store computer instructions executable by the processor. The processor is configured to implement a method for isolating a sound according to any embodiment herein when executing the computer instructions.

According to a fourth aspect herein, a non-transitory computer-readable storage medium has stored thereon a computer program which, when executed by a processor, implements a method for isolating a sound according to any embodiment herein.

According to a fifth aspect herein, a computer program, when executed by a processor, implements a method for isolating a sound according to any embodiment herein

### BRIEF DESCRIPTION OF THE ACCOMPANYING DRAWINGS

Drawings to be used in description of one or more embodiments herein and of related art are introduced briefly for clearer illustration of a technical solution according to one or more embodiments herein and in related art. Note that the drawings described below refer merely to some embodiments herein. For a person having ordinary skill in the art, other drawings may be acquired according to the drawings herein without creative effort.

FIG. 1 is a flowchart of a method for isolating a sound according to at least one exemplary embodiment herein.

FIG. 2 is a flowchart of a method for isolating a sound based on vision according to at least one exemplary embodiment herein.

FIG. 3 is a diagram of a principle corresponding to FIG. 2.

FIG. 4 is a flowchart of a method for isolating a sound according to at least one exemplary embodiment herein.

FIG. 5 is a diagram of a structure of a network corresponding to FIG. 4.

FIG. 6 is a diagram of a structure of a device for isolating a sound according to at least one exemplary embodiment herein.

FIG. 7 is a diagram of a structure of a device for isolating a sound according to at least one exemplary embodiment herein.

FIG. 8 is a diagram of a structure of a device for isolating a sound according to at least one exemplary embodiment herein.

### DETAILED DESCRIPTION

To allow a person having ordinary skill in the art to better understand a technical solution herein, clear complete description to the technical solution herein is given below with reference to the drawings in one or more embodiments herein. Clearly, embodiments illustrated herein are but some, instead of all, embodiments according to the subject disclosure. Based on one or more embodiments herein, a person having ordinary skill in the art may acquire another embodiment without creative effort. Any such embodiment falls within the scope of the subject disclosure.

In related art of sound isolation, mixed sounds may be isolated using a neural network model. In general, isolation may be performed once. That is, sounds from all sound sources in mixed sounds may be isolated via one processing. However, with the isolation technology, sound may be isolated under a strong assumption of a fixed number of sound sources. The strong assumption of a fixed number of sound sources may impact generalizability of a model as well as an effect of sound isolation.

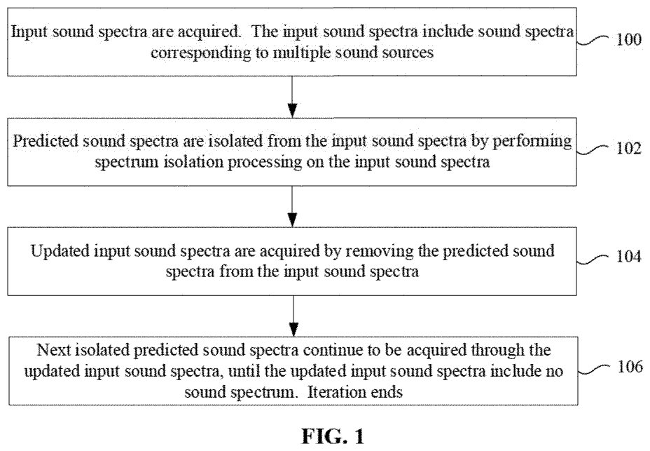

In view of this, embodiments herein provide a method for isolating a sound, capable of performing spectrum isolation on sound spectra of mixed sound sources, improving generalizability of a model as well as improving an effect of sound isolation. As shown in FIG. 1, the method includes processing as follows.

In S100, input sound spectra are acquired. The input sound spectra include sound spectra corresponding to multiple sound sources.

The input sound spectra may be a raw sound file. The sound file may be a file in a format such as MP3, WAV, etc., or may be Short-Time Fourier-Transform (STFT) spectra acquired by performing Fourier transform on a sound file. The input sound spectra may include sound spectra corresponding to multiple sound sources. Sound spectra corresponding to a respective sound source may be isolated subsequently. A sound source herein may be an object that makes sound corresponding to sound spectra. For example, one piece of sound spectra may correspond to a sound source of a piano. The sound spectra may be STFT spectra into which the sound of the piano is converted. Another piece of sound spectra may correspond to a sound source of a violin, and may be STFT spectra into which the sound of the violin is converted.

In S102, predicted sound spectra are isolated from the input sound spectra by performing spectrum isolation processing on the input sound spectra.

For example, herein sound may be isolated iteratively. Sound spectra corresponding to a respective sound source may be isolated from the input sound spectra through multiple iterations. One piece of sound spectra therein may be isolated per iteration. The isolated sound spectra may, be referred to as predicted sound spectra (or predicted spectra). The predicted sound spectra may correspond to one of the sound sources of the input sound spectra.

The step may be one iteration during iterative isolation, such as an ith iteration, through which the predicted sound spectra corresponding to one of the sound sources may be isolated. Note that spectrum isolation processing may be performed on the input sound spectra here in any mode, which is not limited herein. For example, spectrum isolation may be performed based on a video frame corresponding to the input sound spectra. Alternatively, spectrum isolation may be performed not based on a video frame corresponding to the input sound spectra.

In S104, updated input sound spectra are acquired by removing the predicted sound spectra from the input sound spectra.

In the step, before starting a next iteration, such as an (i+1)th iteration, the predicted sound spectra isolated by the ith iteration may be removed from the input sound spectra, reducing interference to sound spectra remaining in the input sound spectra, facilitating isolation of the remaining sound spectra. After predicted sound spectra isolated by the ith iteration have been removed, the remaining input sound spectra may be the updated input sound spectra.

In S106, next isolated predicted sound spectra continue to be acquired through the updated input sound spectra, until the updated input sound spectra include no sound spectrum. Iteration ends.

In the step, the next iteration may be started to isolate the predicted sound spectra corresponding to another sound source. The iterative isolation may end when the updated input sound spectra do not include sound spectra corresponding to a sound source. For example, the updated input sound spectra may contain only noise. For example, if average energy of the updated input sound spectra is less than a preset threshold, it may be considered that the spectra contains only noise, only small sound components of trivial energy. The small components may be of little significance. No spectrum isolation processing has to be performed on the updated input sound spectra. Then, the iteration may end.

With a method for isolating a sound herein, spectrum isolation is performed on input sound spectra of mixed sound sources by iterative isolation. Predicted sound spectra are isolated by each iteration. The predicted sound spectra are removed from the input sound spectra before next spectrum isolation is performed. In this way, removal of the predicted sound spectra reduces impact of the predicted sound spectra on the remaining sound, rendering the remaining sound increasingly prominent and easier to isolate as the iteration proceeds, thereby improving accuracy in sound isolation, improving effect of isolation. Moreover, iterative isolation of sound ends when the updated input sound spectra include no sound from any sound source. This puts no limit to the number of fixed sound sources. Accordingly, the method may be applied to a scene where there is an uncertain number of sound sources, improving generalizability of the model.

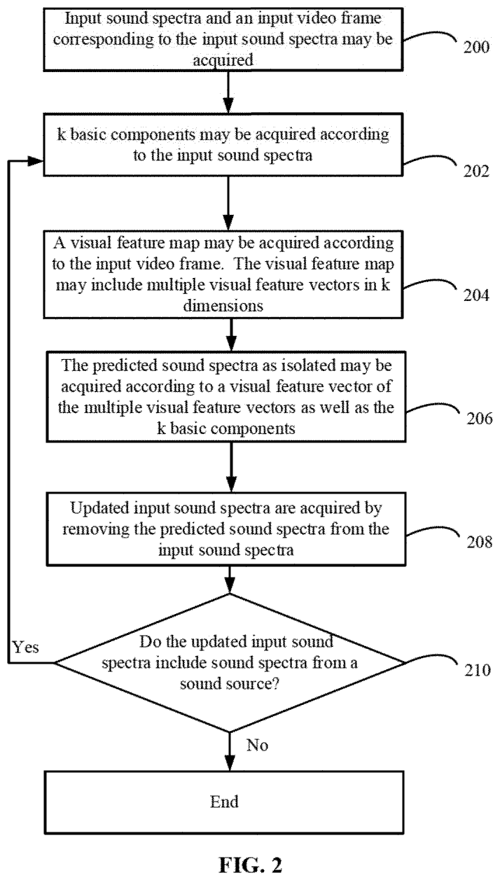

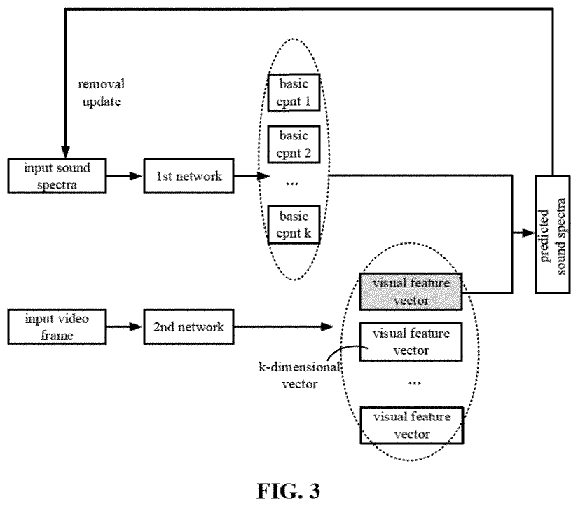

FIG. 2 is a flowchart of a method for isolating a sound based on vision according to at least one exemplary embodiment herein. FIG. 3 is a diagram of a principle corresponding to FIG. 2. With the method according to FIG. 2 and FIG. 3, spectrum isolation may be performed on the input sound spectra based on an input video frame. The method may include processing as follows. Note that the numberings of steps such as S200 or S202 are not to be used as restrictions on the order in which the steps are implemented.

In S200, input sound spectra and an input video frame corresponding to the input sound spectra may be acquired.

In the step, the input sound spectra may represent sound in a waveform form that has been converted into sound spectra, such as STFT spectra. There may be no sound but some picture frames in the input video frame. The input video frame may be a video frame corresponding to the input sound spectra. The input video frame may include multiple sound sources. Respective sound spectra in the input sound spectra may correspond to a respective sound source in the input video frame.

In S202, k basic components may be acquired according to the input sound spectra.

In the step, the input sound spectra may be input to a first network. The first network may output k basic components. The first network may extract sound features in the input sound spectra. For example, the first network may be a U-Net. The k basic components may represent respective sound features in the input sound spectra. A sound feature may be used to represent a distinct sound attribute in spectra. Understandably, sounds generated by different sound sources may have identical sound features. Sounds generated by one sound source may have different sound features, which is not limited hereto. For example, the input sound spectra may include sounds from three sound sources, i.e., a piano, a violin, and a flute. Assume that the piano, the violin, and the flute are playing the same key C, the piano, the violin, and the flute may correspond to different sound spectra. One sound source may correspond to more than one sound feature. Therefore, the k may generally, be greater than the number of types of sound sources. The k may be determined based on the number of sound features in the input sound spectra.

In S204, a visual feature map may be acquired according to the input video frame. The visual feature map may include multiple visual feature vectors in k dimensions.

Here, the input sound spectra and the input video frame may be from the same video file. Multiple pieces of sound spectra included in the input sound spectra may correspond respectively to different sound sources. The multiple different sound sources may be sound sources m the input video frame. For example, in a video frame, a boy may be playing the piano. A girl may be playing the violin. The piano and the violin may be two sound sources. Both sound spectra corresponding to sound made by the piano and sound spectra corresponding to sound made by the violin may be included in the input sound spectra.

In the step, the input video frame may be input to a second network, acquiring a visual feature map including multiple visual feature vectors. Each visual feature vector may correspond to a sound source in the input video frame. Each visual feature vector may be a k-dimensional vector. In addition, the second network may also be a U-Net.

In S206, one piece of predicted sound spectra as isolated may be acquired according to a visual feature vector of the multiple visual feature vectors as well as the k basic components.

In an example, referring to the example of FIG. 3, a visual feature vector may be selected from multiple visual feature vectors. Predicted sound spectra currently isolated may be acquired as a dot product of the k-dimensional visual feature vector and a vector made of the k basic components. The dot product of the k-dimensional visual feature vector and the vector of the k basic components may be acquired by multiplying elements of the visual feature vector in respective dimensions and the respective basic components, and then summing over results of the respective multiplications, as shown in formula (1) as follows. The sound source of the predicted sound spectra may be the sound source corresponding to the visual feature vector as selected.

For example, the k basic components may be expressed as {S₁^{sub},S₂^{sub}, . . . , Sₖ^{sub}}. V(x, y, j) may be a visual feature map. The visual feature map may be an x*y*k three-dimensional tensor. The j may range from 1 to k.

The formula (1) illustrates a way to acquire the predicted sound spectra based on the visual feature vector and the basic components.

Sᵢ^{solo}=Σⱼ₌₁^{k}vⱼSⱼ^{sub} (1)

That is, as in formula (1), the k basic components Sⱼ^{sub} and elements in one of the multiple visual feature vectors in k dimensions may be multiplied respectively and then a sum of the products thereof may be acquired to acquire the predicted sound spectra Sᵢ^{solo}. Each of the k elements of the visual feature vectors in the j dimension may represent an estimated correlation between a basic component and video content of the video frame at a spatial location.

In another implementation, the predicted sound spectra may be acquired as follows.

First, a dot product of a vector of the k basic components and one of the visual feature vectors of k elements in k dimensions may be acquired. A predicted mask may be acquired by perforating nonlinear activation processing on the dot product. The predicted mask may result from an operation between the basic components and the visual feature vector. The result may be used to select an object in the input sound spectra to be processed, to isolate the predicted sound spectra in the input sound spectra. The formula (2) illustrates acquisition of the predicted mask M.

$$M = σ ( {\sum }_{j = 1}^{k} {v}_{j} {S}_{j}^{sub} ) \qquad ( 2 )$$

The σ may represent a nonlinear activation function, such as a sigmoid function. Optionally, binarization may be performed on the M to acquire a binarized mask.

Then, the predicted sound spectra may be acquired as a dot product of the predicted mask and initial input sound spectra for a first iteration. The formula (3) illustrates how the predicted sound spectra are acquired. Note that a dot product of the predicted mask in each iteration and initial input sound spectra for a first iteration may be acquired. Each iteration will update the input sound spectra. The updated input sound spectra may be used to generate k basic components in the next iteration. The basic components in turn lead to update of the predicted mask M. As shown in formula (3), a dot product of the predicted mask M in each iteration and the initial input sound spectra S^{mix} may be acquired.

Sᵢ^{solo}=M⊗S^{mix} (2)

In formula (3), the M may be the predicted mask. The S^{mix} may represent the initial input sound spectra for the first iteration. The Sᵢ^{solo} may represent the predicted sound spectra isolated in the ith iteration.

In S208, updated input sound spectra are acquired by removing the predicted sound spectra from the input sound spectra.

For example, referring to the formula (4), the updated input sound spectra Sᵢ^{mix} updated by the ith iteration may be acquired by removing the predicted sound spectra. Sᵢ^{solo} isolated by the ith iteration from the input sound spectra Sᵢ₋₁^{mix} for the (i−1)th iteration.

Sᵢ^{mix}=Sᵢ₋₁^{mix}⊖Sᵢ^{solo} (4)

The ⊖ may represent an element-wise subtraction between sound spectra.

In S210, it may be determined whether the updated input sound spectra include sound spectra from a sound source.

For example, a preset threshold may be set. If average energy of the updated input sound spectra is less than the preset threshold, it means that the updated input sound spectra contain only meaningless noise or are null.

If the updated input sound spectra include no sound spectra from any sound source, the iteration may end, which means that sound from any sound source in the video has been isolated.

If the updated input sound spectra include sound spectra from a sound source, the flow may return to S202 to continue to implement the next iteration according to the updated input sound spectra and the updated input video frame, to continue to acquire the predicted sound spectra isolated next.

The method for isolating a sound here has the following advantages.

First, this method is a process of iterative isolation. A piece of isolated predicted sound spectra are acquired from the input sound spectra. Then, the next iteration is performed. That is, each iteration may isolate a piece of predicted sound spectra. Moreover, the predicted sound spectra acquired by each iteration must be removed from the input sound spectra before the next iteration. Removal of the predicted sound spectra reduces interference to the remaining sound by the predicted sound spectra. For example, loud sound may be taken out first, thereby reducing interference to soft sound by the loud sound, rendering the remaining sound increasingly prominent and easier to isolate as the iteration proceeds, thereby improving accuracy in sound isolation, improving effect of isolation.

Secondly, the iterative isolation may end when the updated input sound spectra do not include sound made by a sound source, such as when average energy of the updated input sound spectra is less than a threshold. This puts no limit to the number of fixed sound sources. Accordingly, the method may be applied to a scene where there is an uncertain number of sound sources, improving generalizability of the model.

According to the method for isolating a sound based on vision, multiple sounds included in a video may be isolated, for example, and a sound source corresponding to each sound may be identified. Exemplarily, a video may include two girls playing music, one girl playing the flute, the other girl playing the violin. In the video, the sounds of the two instruments may be mixed together. Then, sound of the flute and sound of the violin may be isolated as illustrated. In addition, flute sound may be identified as corresponding to the sound source object “flute” in the video, and violin sound may be identified as corresponding to the sound source object “violin” in the video.

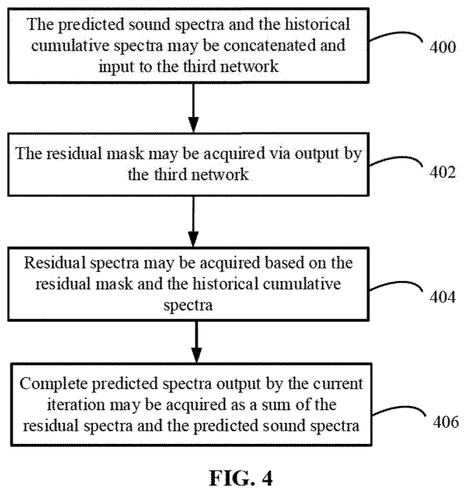

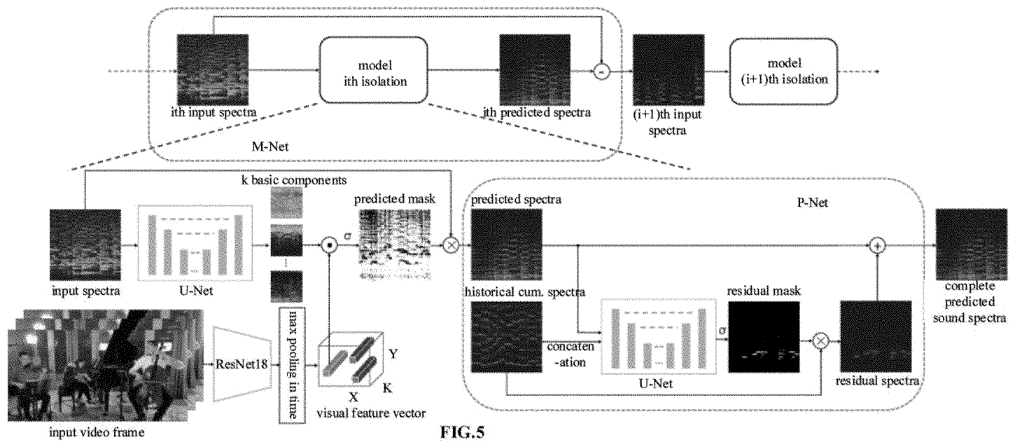

FIG. 4 is a method for isolating a sound as provided herein. The method further improves the method shown in FIG. 2. The predicted sound spectra acquired in FIG. 2 may be further adjusted to acquire complete predicted sound spectra with more complete spectra, further improving effect of sound isolation. FIG. 5 is a diagram of a structure of a network corresponding to FIG. 4. Referring to FIG. 4 and FIG. 5, the method may be as follows.

The network structure may include a Minus Network (M-Net) and a Plus Network (P-Net). The entire network may be referred to as Minus-Plus network (Minus-Plus Net).

One may refer to FIG. 5 for the structure of and processing done by, a M-Net. That is, an M-Net mainly may serve to isolate each sound, i.e., predict the sound spectrum, from the input sound spectra by iteration. Each iteration may isolate one kind of predicted sound spectra, and correlate the predicted sound spectra with a corresponding sound source in the video frame. Predicted sound spectra Sᵢ^{solo} isolated by the M-Net each time may represent predicted sound spectra acquired in the ith iteration.

Regarding processing by the M-Net, content is also illustrated as follows.

First, referring to the example in FIG. 5, the M-Net may include a first network and a second network. The first network may be a U-Net, for example. The input sound spectra may be processed by the U-Net, acquiring k basic components. The second network may be a feature extraction network such as a Residual Network (ResNet) 18, for example. The input video frame may be processed by the ResNet 18. Then, the ResNet 18 may output a video feature of the input video frame. Max pooling may be performed on the video feature in time dimension, acquiring a visual feature map including multiple visual feature vectors. The video feature may be a feature with a time-dimension properly. Pooling by taking a max value may be performed on the video feature in time dimension.

Secondly, in FIG. 5, the predicted sound spectra may be acquired as a dot product of the input sound spectra and the predicted mask, for example.

Thirdly, when acquiring the predicted sound spectra according to a visual feature vector of the multiple visual feature vectors as well as the k basic components, the visual feature vector may be selected in multiple modes.

For example, a visual feature vector may be selected randomly from the multiple visual feature vectors included in the visual feature map for generating the predicted sound spectra.

As another example, a visual feature vector in the input sound spectra that corresponds to a loudest sound source may be selected. Optionally, the visual feature vector corresponding to the loudest sound may be acquired according to formula (5).

$$( {x}^{*} , {y}^{*} ) = {argmax}_{( x , y )} E [ σ ( {\sum }_{j = 1}^{k} V ( x , y , j ) * {S}_{j}^{sub} ) * {S}^{mix} ] \qquad ( 5 )$$

According to the formula (5), each visual feature vector in the visual feature map may be processed as follows. A first product

$${\sum }_{j = 1}^{k} V ( x , y , j ) * {S}_{j}^{sub}$$

of the visual feature vector and a vector of the k basic components may be acquired. A second dot product of the first dot product having been subject to nonlinear activation processing and initial input sound spectra S^{mix} for a first iteration may be acquired. Then, average energy of the second dot product may be acquired. After each visual feature vector has been thus processed, coordinates of the visual feature vector corresponding to the max average energy may be selected. To put it simply, this process may select the sound with max amplitude. The E(.) may represent the average energy of the content in the brackets. The (x*, y*) may be the location of the sound source corresponding to the predicted sound spectra. The video content of the vector may be the video feature corresponding to the predicted sound spectra.

That is, with iterative isolation by the M-Net, it may be selected to isolate the loudest sound at each iteration. The sounds therein may be isolated one by one in a descending order of volume. The order is advantageous, because as loud sound components are gradually removed, the low-volume components in the input sound spectra will gradually become prominent, which helps to better isolate the low-volume sound components.

In addition, here, after the M-Net has acquired the predicted sound spectra, the predicted sound spectra may be perfected and adjusted through the P-Net, adding sound components shared by sounds removed from the first iteration to the (i−1)th iteration and sound acquired in the ith iteration, rendering spectra of sound isolated by the ith iteration more complete. Referring to FIG. 5, the historical cumulative spectra may be the sum of the historical complete predicted sound spectra before the current iteration. For example, if the ith iteration is the first iteration, the historical cumulative spectra may be set to 0. After the first iteration, the P-Net will output one piece of complete predicted sound spectra. Then, the historical cumulative spectra used in the second iteration may be “0+ complete predicted sound spectra acquired by the first iteration”.

Referring to FIG. 5 and FIG. 4 still, the P-Net may perform processing as follows.

In S400, the predicted sound spectra and the historical cumulative spectra may be concatenated and input to the third network.

The predicted sound spectra and the historical cumulative spectra may be concatenated and then input to the third network. For example, the third network may also be a U-Net.

In S402, the residual mask may be acquired via output by the third network.

The residual mask may be acquired by performing, by a function sigmoid, nonlinear activation on the output by the third network.

In S404, residual spectra may be acquired based on the residual mask and the historical cumulative spectra.

For example, in the formula (6), the residual spectra Sᵢ^{residual} may be acquired as a dot product of the residual mask Mᵣ and the historical cumulative spectra Sᵢ^{remix}.

Sᵢ^{residual}=Sᵢ^{remix}⊕Mᵣ (6)

In S406, complete predicted sound spectra output by the current iteration may be acquired as a sum of the residual spectra and the predicted sound spectra.

For example, the formula (7) shows the process, and finally the complete predicted sound spectra Sᵢ^{solo, final} may be acquired.

Sᵢ^{solo, final}=Sᵢ^{solo}⊕Sᵢ^{residual} (7)

Of course, the complete predicted sound spectra (also referred to as complete predicted spectra) may be combined with phase information corresponding thereto, and the currently isolated sound waveform may be acquired through inverse STFT.

In addition, here, the complete predicted sound spectra output by the ith iteration will be removed from the input sound spectra for the ith iteration, acquiring updated input sound spectra. The updated input sound spectra may serve as input sound spectra for the (i+1)th iteration. In addition, the complete predicted sound spectra from the ith iteration will be accumulated to the historical cumulative spectra in FIG. 5. The updated historical cumulative spectra will take part in the (i+1)th iteration.

Optionally, in other implementation, the historical cumulative spectra may also be the sum of the historical predicted sound spectra before the current iteration. The historical predicted sound spectra may be the predicted sound spectra isolated by the M-Net. The input sound spectra may be updated by removing the predicted sound spectra Sᵢ^{solo} isolated by the ith iteration from the input sound spectra for the ith iteration.

With the method for isolating a sound in the embodiment, not only sounds of various volumes in the input sound spectra may gradually become prominent through iterative isolation, thereby acquiring a better isolation effect, but by including processing by the P-Net, the final acquired complete prediction sound spectra may be made more complete, increasing spectrum quality.

The Minus-Plus Net may be trained as follows.

A training sample may be acquired as follows.

In order to acquire the true value of each sound component in mixed sound, N videos each containing only an individual sound may be randomly selected. Then, waveforms of the N sounds may be directly added and then averaged. The average value may be used as the mixed sound. The respective individual sound may be the true value of each sound component in the mixed sound. The input video frame may be acquired directly by concatenation. Alternatively, space-time pooling may be performed on an individual video frame, acquiring a k-dimensional vector. A total of N visual feature vectors may be acquired.

In addition, a number of videos acquired by mixing individual sounds sufficient for model training may be generated.

Training may be done using a method as follows.

For example, the Minus-Plus Net as shown in FIG. 5 may involve a first network, a second network, and a third network. The training process may adjust a network parameter of at least airy one of the three networks. For example, network parameters of the three networks may be adjusted, or the network parameter of one of the networks may be adjusted.

For example, if there are N sounds in a video acquired by mixing individual sounds, N iterative predictions may be performed during training. Refer to an aforementioned method for isolating a sound herein for sound isolation in training, which is not repeated. Each iteration may isolate a sound, acquiring complete predicted sound spectra.

Exemplarily, a loss function used in the training process may include a first loss function and a second loss function. For example, the first loss function for each iteration may be used to measure an error between a true value and a predicted value of the predicted mask M and the residual mask Mr. For example, when the mask is a binarized mask, a binarized cross entropy loss function may be used. In addition, after the N iterations have been performed, a second loss function may be used to measure an error between the updated input sound spectra after the last iteration and a piece of empty sound spectra. An individual-sound mixed video containing N sounds may be a training sample. Multiple samples together may form a batch.

After N iterations of a sample, a back propagation is performed. After N iterations of an individual-sound mixed video, back propagation may be performed combining the first loss function and second loss function, to adjust the first network, the second network, and the third network. Then, a model parameter may continue to be trained and adjusted through the next video acquired by mixing individual sounds until the loss is less than a predetermined error threshold, or a predetermined number of iterations are performed.

In addition, the Minus-Plus Net shown in FIG. 5 may be trained in three steps. The first step may be to train the M-Net alone. The second step may be to train the P-Net alone while fixing the parameter of the M-Net. The third step may be to jointly train the M-Net and the P-Net. Of course, the M-Net and the P-Net may be trained only through joint training.

If sound is isolated using only one M-Net but no P-Net, a similar method may be used to adjust network parameters of the first network and the second network in the M-Net.

For example, the method for isolating a sound herein may be elaborated with the example that the input sound spectra include three sound sources, i.e., the piano, the violin, and the flute. The method for isolating a sound may include three iterations. If the violin is louder than the piano and the piano is louder than the flute, then first predicted sound spectra corresponding to the violin may be isolated by the first iteration. Second predicted sound spectra corresponding to the piano may be isolated by the second iteration. Third predicted sound spectra corresponding to the flute may be isolated by the third iteration.

During the first iteration, input sound spectra including the three sound sources may be acquired. k basic components may be acquired according the input sound spectra. An input video frame corresponding to the input sound spectra may be acquired. A visual feature map including 3 visual feature vectors in k dimensions may be acquired according to the input video frame. The first k-dimensional visual feature vector may correspond to the violin. The second k-dimensional visual feature vector may correspond to the piano. The third k-dimensional visual feature vector may correspond to the flute. The volume corresponding to the first k-dimensional visual feature vector may be greater than the volume corresponding to the second k-dimensional visual feature vector. The volume corresponding to the second k-dimensional visual feature vector may be greater than the volume corresponding to the third k-dimensional visual feature vector. The first k-dimensional visual feature vector may be selected based on the visual feature map. A product of the first k-dimensional visual feature vector and a vector made of the k basic components may be acquired. Nonlinear activation may be performed on the product of the two vectors to acquire a first predicted mask corresponding to the first k-dimensional visual feature vector. The first predicted sound spectra may be acquired as a dot product of the first predicted mask and the input sound spectra. The first predicted sound spectra may be removed from the input sound spectra, acquiring first updated input sound spectra. Then, it may be determined whether the first updated input sound spectra include sound spectra. If the first updated input sound spectra include sound spectra, the second iteration may continue to be performed. In some embodiments, after the first predicted sound spectra have been acquired, the first k-dimensional visual feature vector in the visual feature map may be given a value −∞, acquiring a first updated visual feature map. Combining the formula 5, after the first predicted sound spectra have been acquired, the first k-dimensional visual feature vector will not be selected again.

During the second iteration, k basic components may be acquired according to the first updated input sound spectra. A component in the k basic components corresponding to the violin may be 0. The second k-dimensional visual feature vector corresponding to the max volume may be selected from the first updated visual feature map. A product of the second k-dimensional visual feature vector and the vector made of the k basic components may be acquired. Nonlinear activation may be performed on the product of the two vectors to acquire a second predicted mask corresponding to the second k-dimensional visual feature vector. The second predicted sound spectra may be acquired as a dot product of the second predicted mask and the input sound spectra. The second predicted sound spectra may be removed from the first updated input sound spectra, acquiring second updated input sound spectra. Then, it may be determined whether the second updated input sound spectra include sound spectra. If the second updated input sound spectra include sound spectra, the third iteration may continue to be performed. In some embodiments, after the second predicted sound spectra have been acquired, the second k-dimensional visual feature vector in the first updated visual feature map may be given a value −∞, acquiring a second updated visual feature map. Combining the formula 5, after the second predicted sound spectra have been acquired, the second k-dimensional visual feature vector will not be selected again.

During the third iteration, k basic components may be acquired according to the second updated input sound spectra. A component in the k basic components corresponding to the violin may be 0. A component in the k basic components corresponding to the piano may be 0. The third k-dimensional visual feature vector may be selected from the second updated visual feature map. A product of the third k-dimensional visual feature vector and the vector made of the k basic components may be acquired. Nonlinear activation may be performed on the product of the two vectors to acquire a third predicted mask corresponding to the third k-dimensional visual feature vector. The third predicted sound spectra may be acquired as a dot product of the third predicted mask and the input sound spectra. The third predicted sound spectra may be removed from the second updated input sound spectra, acquiring third updated input sound spectra. Then, it may be determined whether the third updated input sound spectra include sound spectra. If the third updated input sound spectra include no sound spectra, the iteration may end.

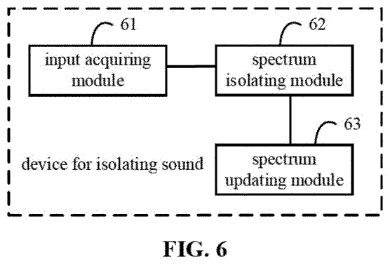

FIG. 6 provides a diagram of a structure of a device for isolating a sound in one embodiment. The device may perform the method for isolating a sound according to any embodiment herein. The device part is briefly described in an embodiment below. Refer to a part of a method embodiment for details of a step implemented by a module of the device. As shown in FIG. 6, the device may include an input acquiring module 61, a spectrum isolating module 62, and a spectrum updating module 63.

The input acquiring module 61 is configured to acquire input sound spectra. The input sound spectra include sound spectra corresponding to multiple sound sources.

The spectrum isolating module 62 is configured to isolate a piece of predicted sound spectra from the input sound spectra by performing spectrum isolation processing on the input sound spectra, the predicted sound spectra corresponding to a sound source in the input sound spectra; and continue to acquire next isolated predicted sound spectra through updated input sound spectra, until the updated input sound spectra include no sound spectrum corresponding to any sound source; then, ending the iteration.

The spectrum updating module 63 is configured to acquire the updated input sound spectra by removing the predicted sound spectra from the input sound spectra.

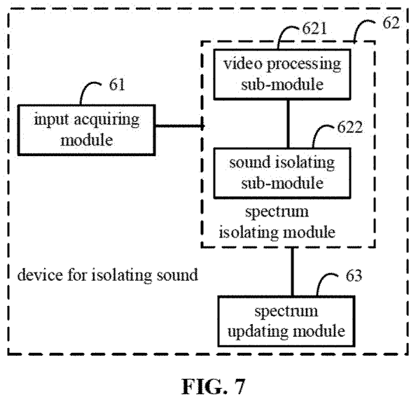

In one embodiment, as shown in FIG. 7, the spectrum isolating module 62 of the device may include a video processing sub-module 621 and a sound isolating sub-module 622.

The video processing sub-module 621 may be configured to acquire an input video frame corresponding to the input sound spectra. The input video frame may include the multiple sound sources. Each piece of sound spectra in the input sound spectra may correspond to a sound source in the input video frame.

The sound isolating sub-module 622 may be configured to isolate a piece of predicted sound spectra from the input sound spectra by performing spectrum isolation processing on the input sound spectra according to the input video frame.

In one embodiment, the video processing sub-module 621 may be configured to acquire a visual feature map according to the input video frame. The visual feature map may include multiple visual feature vectors in k dimensions. Each visual feature vector of the multiple visual feature vectors may correspond to one sound source in the input video frame.

The sound isolating sub-module 622 may be configured to acquire k basic components according to the input sound spectra, the k basic components representing respective sound features in the input sound spectra, the k being a natural number; and acquire a piece of isolated predicted sound spectra according to a visual feature vector of the multiple visual feature vectors as well as the k basic components. A sound source of the predicted sound spectra may be a sound source corresponding to the visual feature vector.

In one embodiment, the video processing sub-module 621 may be configured to implement: outputting a video feature of the input video frame by inputting the input video frame to a feature extraction network; and acquiring the visual feature map including the multiple visual feature vectors by performing max pooling on the video feature in time dimension.

In one embodiment, the sound isolating sub-module 622 may be configured to acquire the predicted sound spectra as a dot product of a vector of the k basic components and the visual feature vector of k elements.

In one embodiment, the sound isolating sub-module 622 may be configured to implement: acquiring a dot product of a vector of the k basic components and the visual feature vector of k elements; acquiring a predicted mask by performing nonlinear activation processing on the dot product; and acquiring the predicted sound spectra as a dot product of the predicted mask and initial input sound spectra for a first iteration.

In one embodiment, the sound isolating sub-module 622 may be configured to implement: randomly selecting a visual feature vector from the multiple visual feature vectors; and acquiring the predicted sound spectra according to the visual feature vector selected and the k basic components.

In one embodiment, the sound isolating sub-module 622 may be configured to implement: selecting, from the multiple visual feature vectors, a visual feature vector corresponding to a loudest sound source; and acquiring the predicted sound spectra according to the visual feature vector selected and the k basic components.

In one embodiment, the sound isolating sub-module 622 may be configured to implement: acquiring a first dot product of a vector of the k basic components and the each visual feature vector of the multiple visual feature vectors; acquiring a second dot product of the first dot product having been subject to nonlinear activation and initial input sound spectra for a first iteration; acquiring average energy of the second dot product; and selecting a visual feature vector corresponding to a location of max average energy

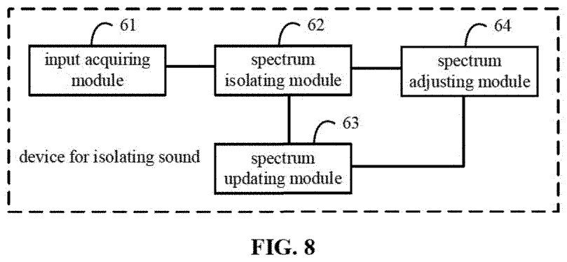

In one embodiment, as shown in FIG. 8, the device may further include a spectrum adjusting module 64 configured to implement: acquiring a residual mask according to the predicted sound spectra and historical cumulative spectra, the historical cumulative spectra being a sum of historical predicted sound spectra isolated before current isolation; acquiring residual spectra based on the residual mask and the historical cumulative spectra; and acquiring complete predicted sound spectra as a sum of the residual spectra and the predicted sound spectra.

In one embodiment, the spectrum updating module 64 may be configured to acquire the updated input sound spectra by removing the complete predicted sound spectra from the input sound spectra. The sum of the historical predicted sound spectra may include a sum of historical complete predicted sound spectra.

In one embodiment, the spectrum isolating module 62 may be configured to implement, in response to average energy of the updated input sound spectra being less than a preset threshold, determining that the input sound spectra include no sound spectra corresponding to any sound source.

Embodiments herein further provide electronic equipment. The equipment includes memory and a processor. The memory is configured to Store computer instructions executable by the processor. The processor is configured to implement the method for isolating a sound according to any embodiment herein.

Embodiments herein further provide a transitory or non-transitory computer-readable storage medium, having stored thereon a computer program which, when executed by a processor, implements the method for isolating a sound according to any embodiment herein.

Embodiments herein further provide a computer program. When executed by a processor, the computer program implements the method for isolating a sound according to any embodiment herein.

A person having ordinary skill in the art should understand that one or more embodiments herein may be provided as a method, a system, or a computer-program product. Therefore, one or more embodiments herein may be implemented in form of an all-hardware embodiment, an all-software embodiment, or an embodiment combining software and hardware. Moreover, one or more embodiments herein may be in the form of a computer-program product implemented on one or more computer-usable storage media (including, but not limited to disk memory, CD-ROM, or optical memory, etc.) containing computer-usable codes.

Embodiments herein further provide a transitory or non-transitory computer-readable storage medium, having stored thereon a computer program which, when executed by a processor, implements steps of the sound separating method described in any embodiment herein, and/or implements steps of the method for training a plus-minus network as described in any embodiment herein. By the “and/or”, it means at least one of the two. For example, “A and/or B” includes three solutions, i.e., A, B, and “A and B”.

Various embodiments herein are described progressively. Refer to an identical or similar part in one embodiment for the part in another. Each embodiment focuses on what differs from other embodiments. In particular, data processing equipment embodiment is described briefly since it is basically similar to the method embodiment. Refer to some description of the method embodiment for a related part thereof.

Specific embodiments herein have been described. Other embodiments are within the scope of the appended claims. In some cases, an action or step recited in the claims may be implemented in an order differing from that in an embodiment while still achieving a desired result. In addition, processes depicted in a drawing do not necessarily require the specific or successive order as shown to achieve a desired result. In some implementation, multitasking and parallel processing are possible or may be advantageous.

Embodiments of a subject described herein as well as a functional operation may be implemented in a digital electronic circuit, a tangible computer software or firmware, computer hardware including a structure disclosed herein and any structural equivalent thereof, or one or more combinations thereof. Embodiments of a subject described herein may be implemented as one or more computer programs, that is, one or more modules in computer program instructions that are encoded on a tangible non-transitory program carrier to be executed by, or to control operation of, data processing equipment. Alternatively or additionally, the program instructions may be encoded on a manually generated propagating signal, such as a machine-generated electrical, optical, or electromagnetic signal. The signal is generated to encode and transmit information to a suitable receiver device so as to be executed by data processing equipment. A computer storage medium may be machine-readable storage equipment, a machine-readable storage substrate, a random or serial access memory equipment, or one or more combinations thereof.

A processing and logic flow described herein may be implemented by one or more programmable computers executing one or more computer programs, to perform a corresponding function by operating according to input data and generating output. The processing and logic flow may also be implemented by a dedicated logic circuit, such as a Field Programmable Gate Array (FPGA) or an Application Specific Integrated Circuit (ASIC). In addition, the device may also be implemented as a dedicated logic circuit.

A computer suitable for executing a computer program may include a general-purpose microprocessor and/or a special-purpose microprocessor, or any other type of central processing unit (CPU), for example. In general, a CPU will receive instructions and data from read-only memory and/or random access memory. A basic component of a computer may include a CPU for implementing or executing instructions and one or more memory equipment for storing instructions and data. In general, the computer will also include one or more mass storage equipment for storing data, such as magnetic disks, magneto-optical disks, or CDs. Alternatively, the computer will be operatively coupled to the mass storage equipment to receive data from the mass storage equipment and/or send data to the mass storage equipment. However, the computer does not have to have such equipment. In addition, the computer may be be embedded in another equipment, such as a mobile phone, a personal digital assistant (PDA), a mobile audio or video player, a game console, a global positioning system (GPS) receiver, of portable storage equipment of a universal serial bus (USB) Flash drive, to name a few.

A computer-readable medium suitable for storing computer program instructions and data may include all forms of non-volatile memory, media, and memory equipment, such as including semiconductor memory equipment (such as EPROM, EEPROM, and flash memory equipment), a magnetic disk (such as an internal hard disk or a removable disk), a magneto-optical disk, a CD ROM disk, as well as a DVD-ROM disk. A processor and memory can be supplemented with, or incorporated into, a dedicated logic circuit.

Although the subject disclosure contains many implementation details, these should not be construed as limiting the scope of any disclosure or the scope of protection. Rather, they mainly serve to describe a feature of a specific embodiment of specific disclosure. Some features described in multiple embodiments herein may also be combined and implemented in a single embodiment. On the other hand, various features described in a single embodiment may also be implemented separately in multiple embodiments, or implemented in form of any suitable sub-combination. In addition, although a feature may function in some combinations as described and even initially claimed as such, one or more features from a claimed combination may in some cases be removed from the combination, and the claimed combination may point to a sub-combination or a variant of the sub-combination.

Similarly, although operations are depicted in a specific order in the drawings, this should not be construed as requiring these operations to be performed in the specific order as shown or performed sequentially, or requiring all illustrated operations to be performed to achieve a desired result. In some cases, multitasking and parallel processing may be advantageous. In addition, separation of various system modules and components in the embodiments should not be understood as requiring such separation in all embodiments, and it should be understood that in general described program components and systems may be integrated in a single software product, or packed into multiple software products.

Thus, specific embodiments of the subject matter have been described. Other embodiments are within the scope of the appended claims. In some cases, the actions recited in the claims can be implemented in a different order while still achieving a desired result. In addition, processes depicted in the drawings are not necessarily in the specific order as shown or in a sequential order in order to achieve a desired result. In some implementations, multitasking and parallel processing may be advantageous.

What described are merely one or more embodiments herein, and are not intended to limit the scope of the subject disclosure. Any modification, equivalent replacement, improvement, etc., made within the spirit and principle of one or more embodiments herein should be included in the scope of one or more embodiments herein.

What is claimed is:

1. A method for isolating a sound, comprising:
acquiring input sound spectra, the input sound spectra comprising sound spectra corresponding to multiple sound sources;
isolating predicted sound spectra from the input sound spectra by performing spectrum isolation processing on the input sound spectra;
acquiring updated input sound spectra by removing the predicted sound spectra from the input sound spectra; and
continuing to acquire next isolated predicted sound spectra through the updated input sound spectra, until the updated input sound spectra comprise no sound spectrum.

2. The method of claim 1, wherein isolating the predicted sound spectra from the input sound spectra by performing spectrum isolation processing on the input sound spectra comprises:
acquiring an input video frame corresponding to the input sound spectra, the input video frame comprising the multiple sound sources; and
isolating the predicted sound spectra from the input sound spectra by performing spectrum isolation processing on the input sound spectra according to the input video frame.

3. The method of claim 2, wherein isolating the predicted sound spectra from the input sound spectra by performing spectrum isolation processing on the input sound spectra according to the input video frame comprises:
acquiring k basic components according to the input sound spectra, the k basic components representing respective sound features in the input sound spectra, the k being a natural number;
acquiring a visual feature map according to the input video frame, the visual feature map comprising multiple visual feature vectors in k dimensions, each visual feature vector of the multiple visual feature vectors corresponding to one sound source in the input video frame; and
acquiring the predicted sound spectra according to a visual feature vector of the multiple visual feature vectors as well as the k basic components, a sound source of the predicted sound spectra being a sound source corresponding to the visual feature vector.

4. The method of claim 3, wherein acquiring the visual feature map according to the input video frame comprises:
outputting a video feature of the input video frame by inputting the input video frame to a feature extraction network; and
acquiring the visual feature map comprising the multiple visual feature vectors by performing max pooling on the video feature in time dimension.

5. The method of claim 3, wherein acquiring the predicted sound spectra according to the visual feature vector of the multiple visual feature vectors as well as the k basic components comprises:
acquiring the predicted sound spectra as a dot product of a vector of the k basic components and the visual feature vector of k elements.

6. The method of claim 3, wherein acquiring the predicted sound spectra according, to the visual feature vector of the multiple visual feature vectors as well as the k basic components comprises:
acquiring a dot product of a vector of the k basic components and the visual feature vector of k elements;
acquiring a predicted mask by performing nonlinear activation processing on the dot product; and
acquiring the predicted sound spectra as a dot product of the predicted mask and initial input sound spectra for a first iteration.

7. The method of claim 3, wherein acquiring the predicted sound spectra according to the visual feature vector of the multiple visual feature vectors as well as the k basic components comprises:
randomly selecting a visual feature vector from the multiple visual feature vectors; and
acquiring the predicted sound spectra according to the visual feature vector selected and the k basic components.

8. , The method of claim 3, wherein acquiring the predicted sound spectra according to the visual feature vector of the multiple visual feature vectors as well as the k basic components comprises:
selecting, from the multiple visual feature vectors, a visual feature vector corresponding to a loudest sound source; and
acquiring the predicted sound spectra according to the visual feature vector selected and the k basic components.

9. The method of claim 8, wherein selecting the visual feature vector corresponding to the loudest sound source comprises:
acquiring a first dot product of a vector of the k basic components and the each visual feature vector of the multiple visual feature vectors;
acquiring a second dot product of the first dot product having been subject to nonlinear activation and initial input sound spectra for a first iteration;
acquiring average energy of the second dot product; and
selecting a visual feature vector corresponding to a location of max average energy.

10. The method of claim 1, further comprising: after isolating the predicted sound spectra from the input sound spectra,
acquiring a residual mask according to the predicted sound spectra and historical cumulative spectra, the historical cumulative spectra being a sum of historical predicted sound spectra isolated during sound isolation;
acquiring residual spectra based on the residual mask and the historical cumulative spectra; and
acquiring complete predicted sound spectra as a sum of the residual spectra and the predicted sound spectra.

11. The method of claim 10, wherein the sum of the historical predicted sound spectra comprises a sum of historical complete predicted sound spectra;
wherein acquiring the updated input sound spectra by removing the predicted sound spectra from the input sound spectra comprises:
acquiring the updated input sound spectra by removing the complete predicted sound spectra from the input sound spectra.

12. The method of claim 10, further comprising: adjusting a network parameter of at least any one of a first network, a second network, and a third network according to an error between the complete predicted sound spectra and true spectra,
wherein k basic components are acquired by inputting the input sound spectra to the first network, wherein a visual feature map is acquired by inputting an input video frame corresponding to the input sound spectra to the second network, wherein the input video frame comprises the multiple sound sources, wherein the residual mask is acquired by inputting the predicted sound spectra and the historical cumulative spectra to the third network.

13. The method of claim 1, further comprising:
in response to average energy of the updated input sound spectra being less than a preset threshold, determining that the updated input sound spectra comprise no sound spectrum.

14. Electronic equipment, comprising memory and a processor, wherein the memory is configured to store computer instructions executable by the processor, wherein when executing the computer instructions, the processor is configured to implement:
acquiring input sound spectra, the input sound spectra comprising sound spectra corresponding to multiple sound sources;
isolating predicted sound spectra from the input sound spectra by performing spectrum isolation processing on the input sound spectra;
acquiring updated input sound spectra by removing the predicted sound spectra from the input sound spectra; and
continuing to acquire next isolated predicted sound spectra through the updated input sound spectra, until the updated input sound spectra comprise no sound spectrum.

15. The electronic equipment of claim 14, wherein the processor is configured to isolate the predicted sound. spectra from the input sound spectra by performing spectrum isolation processing on the input sound spectra by:
acquiring an input video frame corresponding to the input sound spectra, the input video frame comprising the multiple sound sources; and
isolating the predicted sound spectra from the input sound spectra by performing spectrum isolation processing on the input sound spectra according, to the input video frame.

16. The electronic equipment of claim 15, wherein the processor is configured to isolate the predicted sound spectra from the input sound spectra by performing spectrum isolation processing on the input sound spectra according to the input video frame by:
acquiring k basic components according to the input sound spectra, the k basic components representing respective sound features in the input sound spectra, the k being a natural number;
acquiring a visual feature map according to the input video frame, the visual feature map comprising multiple visual feature vectors in k dimensions, each visual feature vector of the multiple visual feature vectors corresponding to one sound source in the input video frame; and
acquiring the predicted sound spectra according to a visual feature vector of the multiple visual feature vectors as well as the k basic components, a sound source of the predicted sound spectra being a sound source corresponding to the visual feature vector.

17. The electronic equipment of claim 16,
wherein the processor is configured to acquire the visual feature map according to the input video frame by: outputting a video feature of the input video frame by inputting the input video frame to a feature extraction network; and acquiring the visual feature map comprising the multiple visual feature vectors by performing max pooling on the video feature in time dimension, and/or
wherein the processor is configured to acquire the predicted sound spectra according to the visual feature vector of the multiple visual feature vectors as well as the k basic components by at least one of:
acquiring the predicted sound spectra as a dot product of a vector of the k basic components and the visual feature vector of k elements, or
acquiring a dot product of a vector of the k basic components and the visual feature vector of k elements; acquiring a predicted mask by performing nonlinear activation processing on the dot product; and acquiring the predicted sound spectra as a dot product of the predicted mask and initial input sound spectra for a first iteration, or
randomly selecting a visual feature vector from the multiple visual feature vectors; and acquiring the predicted sound spectra according to the visual feature vector selected and the k basic components, or
selecting, from the multiple visual feature vectors, a visual feature vector corresponding to a loudest sound source; and acquiring the predicted sound spectra according to the visual feature vector selected and the k basic components,
wherein selecting the visual feature vector corresponding to the loudest sound source comprises:
acquiring a first dot product of a vector of the k basic components and the each visual feature vector of the multiple visual feature vectors; acquiring a second dot product of the first dot product having been subject to nonlinear activation and initial input sound spectra for a first iteration; acquiring average energy of the second dot product; and selecting a visual feature vector corresponding to a location of max average energy.

18. The electronic equipment of claim 14, wherein the processor is further configured to implement: after isolating the predicted sound spectra from the input sound spectra,
acquiring a residual mask according to the predicted sound spectra and historical cumulative spectra, the historical cumulative spectra being a sum of historical predicted sound spectra isolated during sound isolation;
acquiring residual spectra based on the residual mask and the historical cumulative spectra; and
acquiring complete predicted sound spectra as a sum of the residual spectra and the predicted sound spectra,
wherein the sum of the historical predicted sound spectra comprises a sum of historical complete predicted sound spectra;
wherein the processor is configured to acquire the updated input sound spectra by removing the predicted sound spectra from the input sound spectra, by: acquiring the updated input sound spectra by removing the complete predicted sound spectra from the input sound spectra, and/or
wherein the processor is further configured to adjust a network parameter of at least any one of a first network, a second network, and a third network according to an error between the complete predicted sound spectra and true spectra, wherein k basic components are acquired by inputting the input sound spectra to the first network, wherein a visual feature map is acquired by inputting an input video frame corresponding to the input sound spectra to the second network, wherein the input video frame comprises the multiple sound sources, wherein the residual mask is acquired by inputting the predicted sound spectra and the historical cumulative spectra to the third network.

19. The electronic equipment of claim 14, the processor is further configured to implement:
in response to average energy of the updated input sound spectra being less than a preset threshold, determining that the updated input sound spectra comprise no sound spectrum.

20. A non-transitory computer-readable storage medium, having stored thereon a computer program which, when executed by a processor, implements:
acquiring input sound spectra, the input sound spectra comprising sound spectra corresponding to multiple sound sources;
isolating predicted sound spectra from the input sound spectra by performing spectrum isolation processing on the input sound spectra;
acquiring updated input sound spectra by removing the predicted sound spectra from the input sound spectra; and
continuing to acquire next isolated predicted sound spectra through the updated input sound spectra, until the updated input sound spectra comprise no sound spectrum.
